(19) United States
(12) Patent Application Publication
(10) Pub. No.: US 2012/0260617 A1
(43) Pub. Date: Oct. 18, 2012

(54) CHARGING STATION FOR BATTERY-POWERED LAWN MOWER

(75) Inventor: Richard J. Gilpatrick, Whitewater, WI (US)

(73) Assignee: Briggs & Stratton Corporation

(21) Appl. No.: 13/089,193

(22) Filed: Apr. 18, 2011

(51) Int. Cl. A01D 34/00; H02J 7/00

(52) U.S. Cl. 56/11.9; 320/108

(57) ABSTRACT

A lawn mower system includes a lawn mower and a charging station. The lawn mower includes a rechargeable battery, an electric motor powered by the battery, and a secondary coil electrically coupled to the battery. The charging station includes a primary coil configured to induce a current in the secondary coil for charging the battery of the lawn mower.

### BACKGROUND

The present invention generally relates to a system for charging a battery-powered lawn mower. More specifically, the present invention relates to a system including a charging station that uses electromagnetic induction to charge a battery-powered, walk-behind lawn mower.

A battery-powered, walk-behind lawn mower includes an electric motor that drives a cutting blade. The electric motor is powered by a rechargeable battery, such as a pack of lead-acid, nickel-cadmium, or lithium-ion cells. The cutting blade is typically housed in a deck that includes a skirt that is intended to constrain movement of debris, such as grass clippings. The deck and motor are typically supported by a framework of beams or tubular members that extend to a handle. The operator walks behind the mower and guides the mower by lifting, rotating, pulling, pushing forward, and pushing down upon the handle.

The battery-powered, walk-behind lawn mower typically relies upon an operator to plug in the lawn mower after use to charge the battery for the next use of the lawn mower. This process may require that the operator find a power cord, attach the power cord to an outlet, locate the receiving port on the lawn mower for a plug of the power cord, remove a lid or cover on the receiving port, and attach the plug to the lawn mower. This process may be complicated by water or wet debris near the receiving port, such as moist grass clippings. The resulting assembly may include loose or dangling power cords during charging. Subsequent to charging, the process for cleaning up may require removal of the power cord from the lawn mower, winding and storing of the power cord.

### SUMMARY

One embodiment of the invention relates to a lawn mower system, which includes a lawn mower and a charging station. The lawn mower includes a rechargeable battery, an electric motor powered by the battery, and a secondary coil electrically coupled to the battery. The charging station includes a primary coil configured to induce a current in the secondary coil for charging the battery of the lawn mower.

Another embodiment of the invention relates to a charging station for power equipment. The charging station includes a platform configured to receive the power equipment for charging. The platform includes a lip configured to constrain movement of the power equipment, a ramp extending to the lip, and a recessed surface. The ramp is configured to facilitate moving the power equipment over the lip without lifting the power equipment off of the platform. The charging station further includes a coil integrated into the platform and configured to provide a field for charging the power equipment via induction.

Yet another embodiment of the invention relates to a power equipment, which includes a frame having wheels, a rechargeable battery, an electric motor supported by the frame and configured to be receive power from the battery, and a coil configured to generate a current via induction for charging the battery.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a lawn mower on a charging station according to an exemplary embodiment of the invention.

FIG. 2 is a schematic view of a lawn mower on a charging station according to an exemplary embodiment of the invention.

FIG. 3 is a perspective view of a charging station according to another exemplary embodiment of the invention.

FIG. 4 is a perspective view of a charging station according to still another exemplary embodiment of the invention.

FIGS. 5-8 are perspective views of undersides of lawn mowers according to various exemplary embodiments of the invention.

FIG. 9 is front view of a lawn mower according to an exemplary embodiment of the invention.

FIG. 10 is a side view of a lawn mower according to an exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

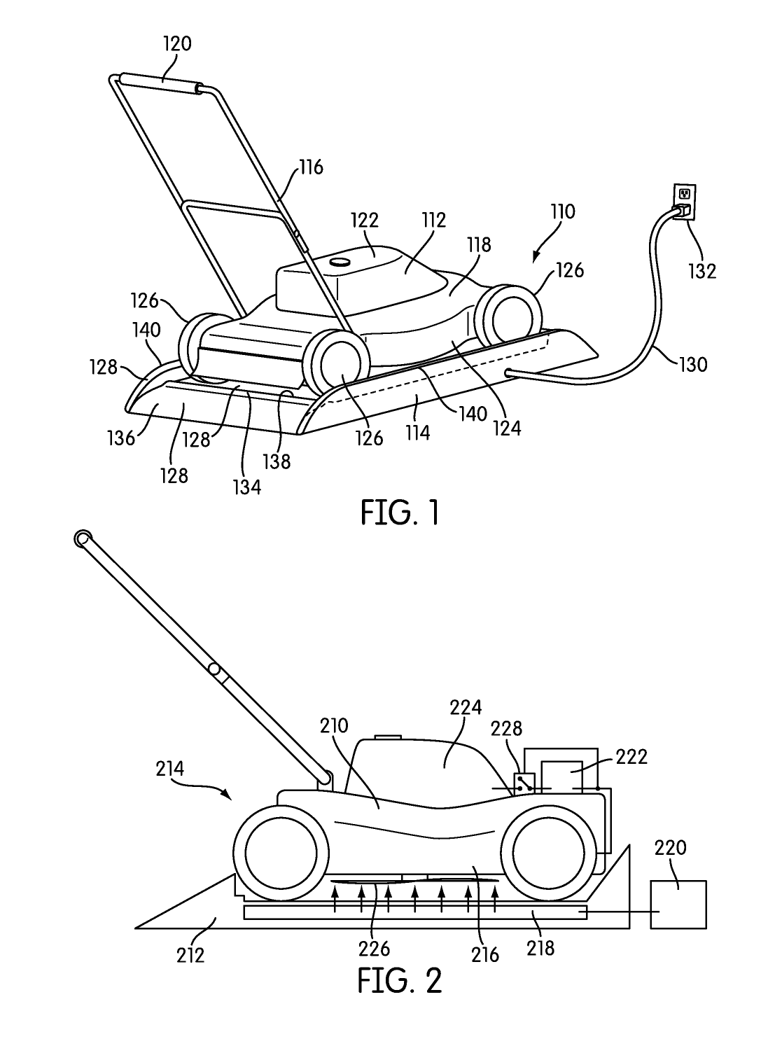

A power equipment system is shown in FIG. 1 as a lawn mower system 110 that includes a battery-powered, walk-behind lawn mower 112 and a charging station 114 (e.g., charging pad, mat). The lawn mower 112 includes a frame 116 supporting a deck 118 and a handle 120. A motor 122 is coupled to the deck 118 and is configured to rotate a blade (see blade 420 as shown in FIG. 4) to cut grass. A skirt 124 extends downward from a top surface of the deck 118. The skirt 124 is designed to control the movement of grass clippings and other debris produced by the lawn mower 112. Four wheels 126 extend from axles coupled to the frame 116 on sides of the deck 118 proximate the skirt 124.

The charging station 114 includes a top surface 128 (e.g., platform) configured to receive the lawn mower 112 and a power cord 130 configured to connect the charging station 114 to a standard outlet 132. The lawn mower 112 may be stored on the charging station 114, and is configured to receive power from the charging station 114 for charging a battery (see, e.g., battery 222 as shown in FIG. 2) of the lawn mower 112. According to an exemplary embodiment, the charging occurs wirelessly, is automatically activated when the lawn mower 112 is positioned on the charging station 114, and is automatically deactivated when the lawn mower 112 is fully charged.

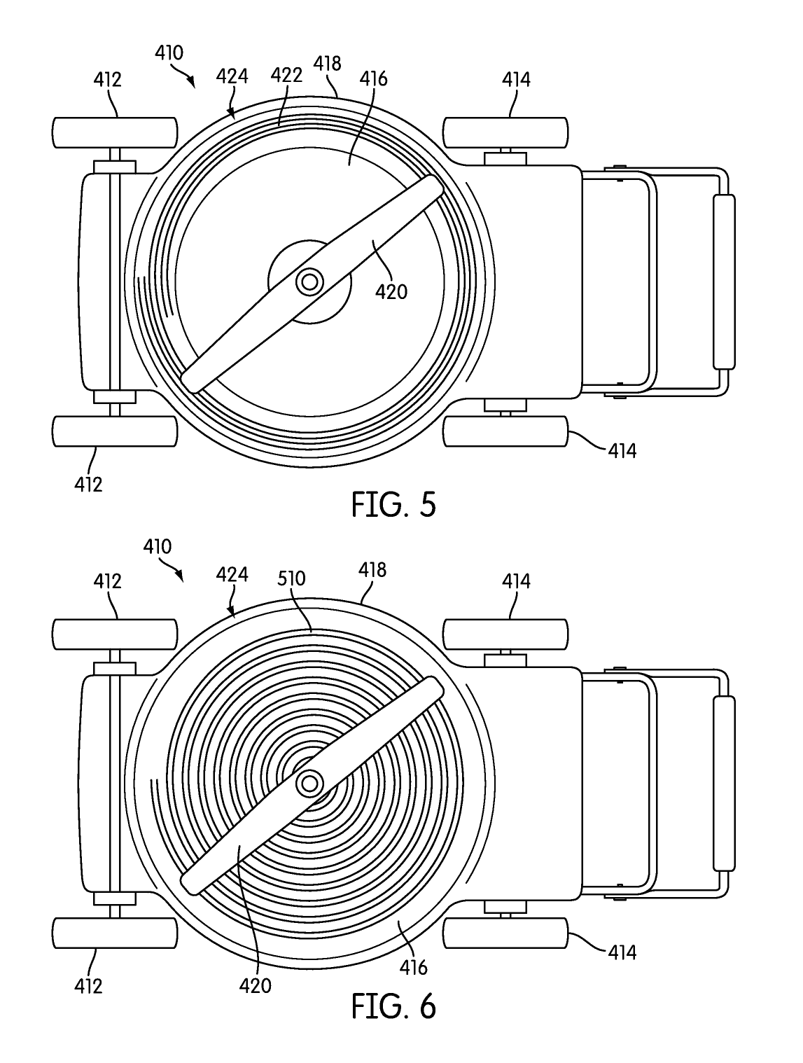

In some embodiments, the top surface 128 is configured to provide power to the lawn mower 112 via a coil (see, e.g., primary coil 218 as shown in FIG. 2) integrated with the charging station 114. The coil wirelessly provides power via induction (e.g., direct induction, electromagnetic induction, magnetic induction power transfer, Tesla inductive coupling method) to a receiving coil (see, e.g., coil 216 as shown in FIG. 5) coupled to the battery of the lawn mower 112. In some embodiments, induction coils of lawn mower system 110 are resonant at about the same frequency and configured to facilitate resonant induction or electro-dynamic induction power transfer. Use of coils configured for resonant induction may improve the efficiency of the power transfer and allow for greater distances between the coils.

According to an exemplary embodiment, the charging station 114 is designed to receive the lawn mower 112 without requiring that the operator lift up the lawn mower 112 (i.e., lift off of the ground) in order to place the lawn mower 112 in position to receive power from the charging station 114. In some embodiments, the operator of the lawn mower 112 rolls the wheels 126 of the lawn mower 112 onto the top surface 128 of the charging station 114. In contemplated embodiments, another form of power equipment slides, hovers, or otherwise moves onto the charging station 114 without requiring that the operator lift the power equipment onto the top surface 128 of the charging station 114. In still other contemplated embodiments, a charging station may require that a user partially or fully lift the power equipment onto the charging station.

In some embodiments, the charging station 114 includes a lip 134 designed to provide a constraint against movement of the lawn mower 112, such as to constrain the lawn mower against being able to roll off of the top surface 128 of the charging station 114 or out of position to receive power from the charging station 114. The lip 134 may extend along one side of the charging station 114, may extend around the entire periphery of the charging station 114, or may only be located in small segments of the charging station 114 that are proximate to where the wheels 126 of the lawn mower 112 are to be positioned in order for the lawn mower 112 to be located and oriented to receive power from the charging station 114. In still other embodiments, a lip or other such structure is adjustable, such as a temporary gate or releasable wall of an enclosure designed to constrain movement of the lawn mower 112 during charging.

According to an exemplary embodiment, the charging station 114 further includes a ramp 136 designed to facilitate movement of the lawn mower 112 or other power equipment up to and over the lip 134. In some embodiments, the ramp 136 is integrated with or integral with the lip 134, which may include another such ramp on the opposite side of the lip 134. According to an exemplary embodiment, the ramp 136 is about sixty degrees or less above horizontal, and is configured to facilitate rolling the wheels 126 of the lawn mower 112 up and over the lip 134.

Still referring to FIG. 1, on the side of the lip 134 opposite to the ramp 136, the charging station 114 includes a recess 138 (e.g., well, recessed surface) providing a stable area for the lawn mower 112 to be placed for charging and storage. In some embodiments, the recess 138 may be fully surrounded by the lip 134. In other embodiments, the charging station 114 further includes a second lip 140 (e.g., wall, raised portion). In some embodiments, the second lip 140 includes at least two sections (e.g., segments, portions) on opposite sides of the charging station 114. The second lip 140 may be taller than the first lip 134, and may be designed to constrain lateral movement of the lawn mower 112 in order to facilitate proper placement of the lawn mower 112 for charging via the charging station 114.

In some embodiments, the charging station 114 is generally rectangular in shape, with a low vertical profile (e.g., less than six inches). The ramp 136 may be located on one side or both of the shorter sides of the rectangle, with the second lip 140 on opposing longer sides. According to an exemplary embodiment, the recess 138 is located adjacent to the ramp 136 and lip 134 such that the wheels 126 of the lawn mower 112 roll up the ramp 136, over the lip 134, and are then constrained in the recess 138 during storage and charging of the lawn mower 112. In some embodiments, the recess 138 also extends between the sections of the second lip 140, which laterally constrain the lawn mower 112 in the recess 138. According to an exemplary embodiment, the recess 138 receives all four wheels 126 of the lawn mower 112, with little extra space between the wheels 126 and the lips 134, 140 (e.g., less than six inches), so as to limit movement of the lawn mower 112 on the charging station 114 and to minimize the dimensions of the charging station 114. While the charging station 114 may have a low vertical profile, in some embodiments the lip 134 has a height of at least a half inch greater than the recess 138 to provide a sufficient constraint to control horizontal movement of the lawn mower 112.

Referring to FIG. 2, a lawn mower 210 is positioned in a recess 214 of a charging station 212 such that a secondary coil 216 of the lawn mower 210 is aligned with a primary coil 218 of the charging station 212. Power is supplied to the primary coil 218 from a source 220, such as an outlet connected to a power grid or generator. Current in the primary coil 218 produces a field that is communicated to the secondary coil 216. In some embodiments, the primary coil 218 is embedded in or covered on the charging station 212 (e.g., sub-surface), and the field is communicated through material of the charging station 212 (e.g., polymeric material). Further, the field may be communicated through air between the charging station 212 and the secondary coil 216 of the lawn mower 210.

According to an exemplary embodiment, current is induced in the secondary coil 216 from the field provided by the primary coil 218. The current is then communicated from the secondary coil 216 to a battery 222 for storage. The battery 222 is coupled to a motor 224 of the lawn mower 210, which is configured to drive a blade 226 of the lawn mower 210. According to an exemplary embodiment, a switch 228 is coupled to the circuit between the battery 222 and the motor 224. The switch 228 opens the circuit when the battery 222 is being charged, and allows the circuit to be closed when the battery 222 is not being charged.

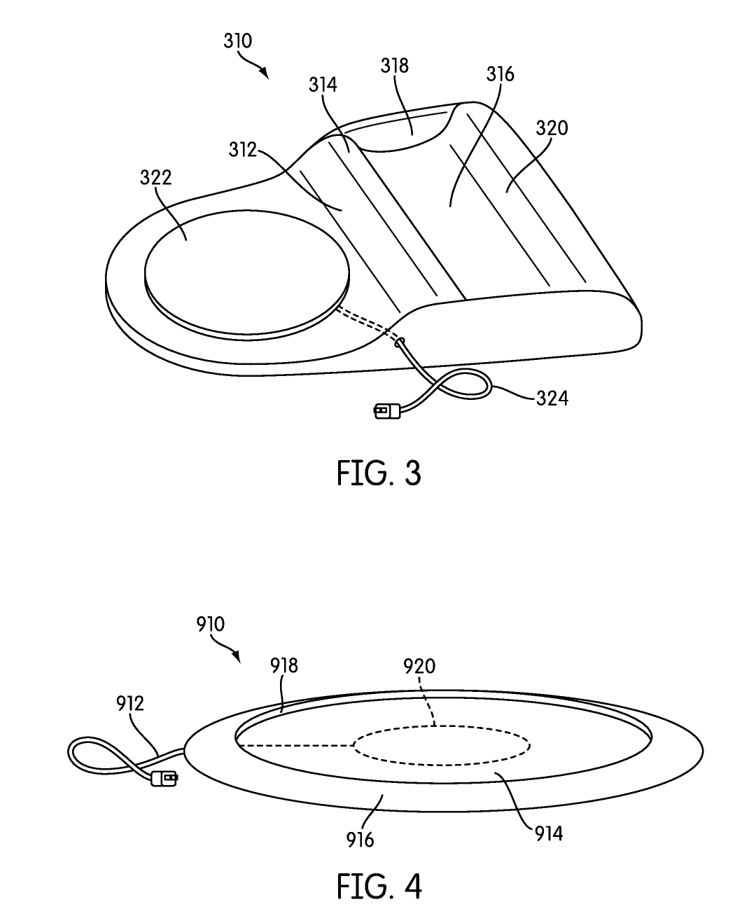

Referring now to FIG. 3, a charging station 310 includes a ramp 312, a lip 314, and a recess 316. The recess 316 is formed between the lip 314, a backstop 320, and a second lip 318 on opposing sides of the recess 316. In some embodiments, the recess 316 is sized to receive two front wheels of a lawn mower or other power equipment (see, e.g., wheels 126 as shown in FIG. 1). When the two front wheels roll up the ramp 312, over the lip 314, and into the recess 316, a primary coil 322 of the charging station 310 is aligned with a secondary coil coupled to the power equipment (see, e.g., coil 216 as shown in FIG. 2). Power is supplied to the primary coil 322 from a source via a power cord 324.

Referring to FIG. 4, a charging station 910 includes a power cord 912 (e.g., cable, wire) coupled to a platform 914. A primary coil 920 is integrated into the platform 914, such as proximate to a center of the platform 914, and is configured to induce a current in a secondary coil of a lawn mower or other power equipment for charging the equipment. The platform 914 is generally round, semi-circular, elliptical, oblique straight oval, oval, or otherwise rounded in shape, and includes a ramp 916 extending to around the platform 914. The ramp 916 may be uniformly angled and extend to a constant height as shown in FIG. 4, or the angle and height of the ramp may vary around the periphery of the platform in other embodiments. According to an exemplary embodiment, the ramp 916 extends to a lip 918, and in other embodiments extends to a plateau or dome. In some embodiments, the platform 914 is sized such that the wheels of the lawn mower (or other power equipment) are constrained by the ramp when the platform is below the deck of the lawn mower. For example, to roll the lawn mower from the charging station 910, wheels of the lawn mower (either front or back) must go up the ramp 916. Accordingly, the ramp 916 constrains the lawn mower in a position for charging. In other contemplated embodiments, a charging station has straight sides and is mound-shaped, with the sides of the mound serving as ramps to similarly constrain the lawn mower.

Referring now to FIG. 5, a lawn mower 410 includes front wheels 412, rear wheels 414, a deck 416 with a skirt 418, a blade 420, and a secondary coil 422. The secondary coil 422 is configured to be aligned with a primary coil of a charging station (see, e.g., charging station 310 as shown in FIG. 3) to receive power via induction to charge a battery of the lawn mower 410. The secondary coil 422 may include hundreds, thousands, or more of overlapping loops of wire (e.g., copper wire) bundled together. In some embodiments, the secondary coil 422 may be embedded in or at least partially surrounded by a cover material designed to protect the wire, such as a tough polymer. Also, the deck 416 may generally be formed from a polymeric material and include shielding (e.g., aluminum foil).

In FIG. 5 the secondary coil 422 is positioned around a rim 424 of the skirt 418 of the deck 416. As such, the secondary coil 422 is located closer to the ground than the blade 420 is to the ground when the lawn mower 410 is upright. In some embodiments, positioning of the secondary coil 422 below the blade 420 and closer to the primary coil of the charging station may help to reduce interference between the secondary coil 422 or the primary coil and the blade, which may be formed from a conductive material (e.g., steel). The secondary coil 422 may also be located closer to the ground (or the primary coil) than to the blade 420; or stated another way, the distance between the secondary coil 422 and the blade 420 may be greater than the distance between the secondary coil 422 and the ground (or the primary coil).

In contemplated embodiments, a blade of the lawn mower is formed from a nonconductive material, such as composite, ceramic, polymer-reinforced ceramic, which may reduce interference in the field generated by the primary coil relative to a steel blade. In other contemplated embodiments, a lawn mower may be configured to physically raise the blade or lower the secondary coil during charging to reduce interference. In still other contemplated embodiments, a blade is located closer to the primary coil than the secondary coil of the deck is to the primary coil when the lawn mower is upright in the charging station, or closer to the secondary coil than the secondary coil is to the primary coil when the lawn mower is upright in the charging station, and any associated interference of the blade in power transfer is accounted for as an acceptable inefficiency of the design.

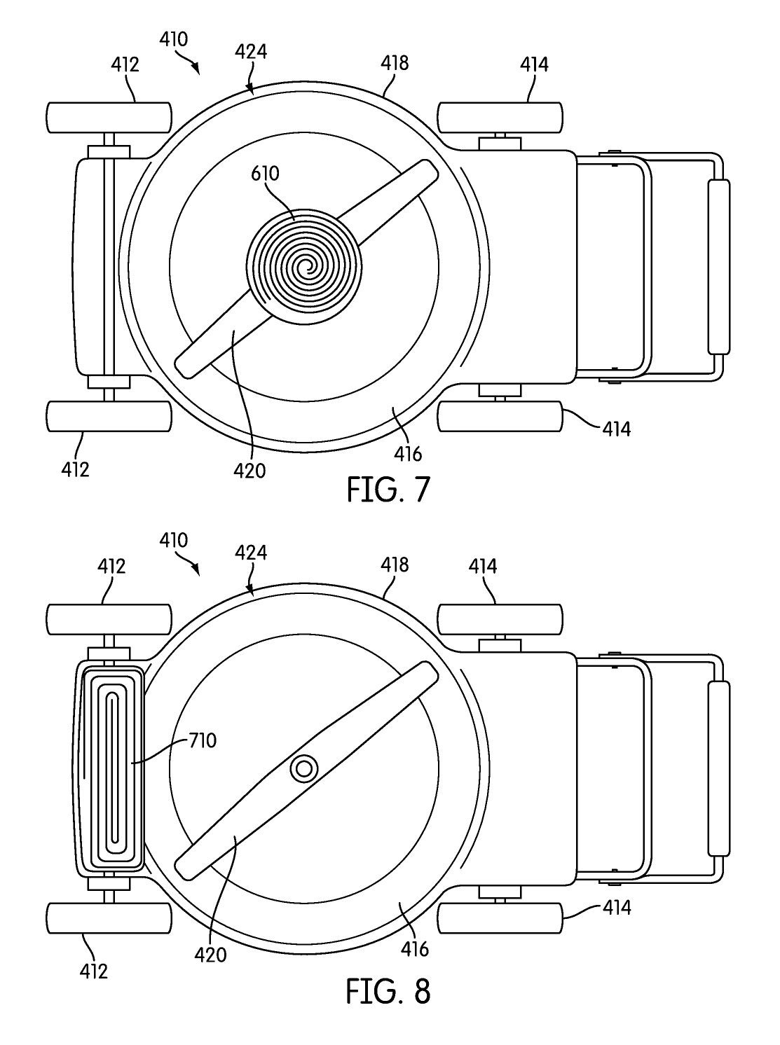

Referring now to FIGS. 6-8, secondary coils 510, 610, 710 may be positioned in various locations on the underside of the lawn mower 410 in addition to or in place of the rim 424 of the skirt 418. In FIG. 6, the secondary coil 510 is integrated with an upper portion of the deck 416, such as the top surface of the deck 416. Materials selected for the blade 420 and other components may be designed to minimize interference between a primary coil and the secondary coil 510. In FIG. 7, a secondary coil 610 extends from a shaft of the blade 420. The secondary coil 610 may be fixed to the shaft, or may be lowered during charging. In FIG. 8, a secondary coil 810 is coupled to a forward portion of the lawn mower, between the front wheels 412 and out of the way of the blade 420. An axle between the front wheels 412 may be formed from a nonconductive material. Similarly, a secondary coil in other contemplated embodiments, may be located to a side or rear of the cutting chamber on the underside of the lawn mower 410, or in combinations of locations.

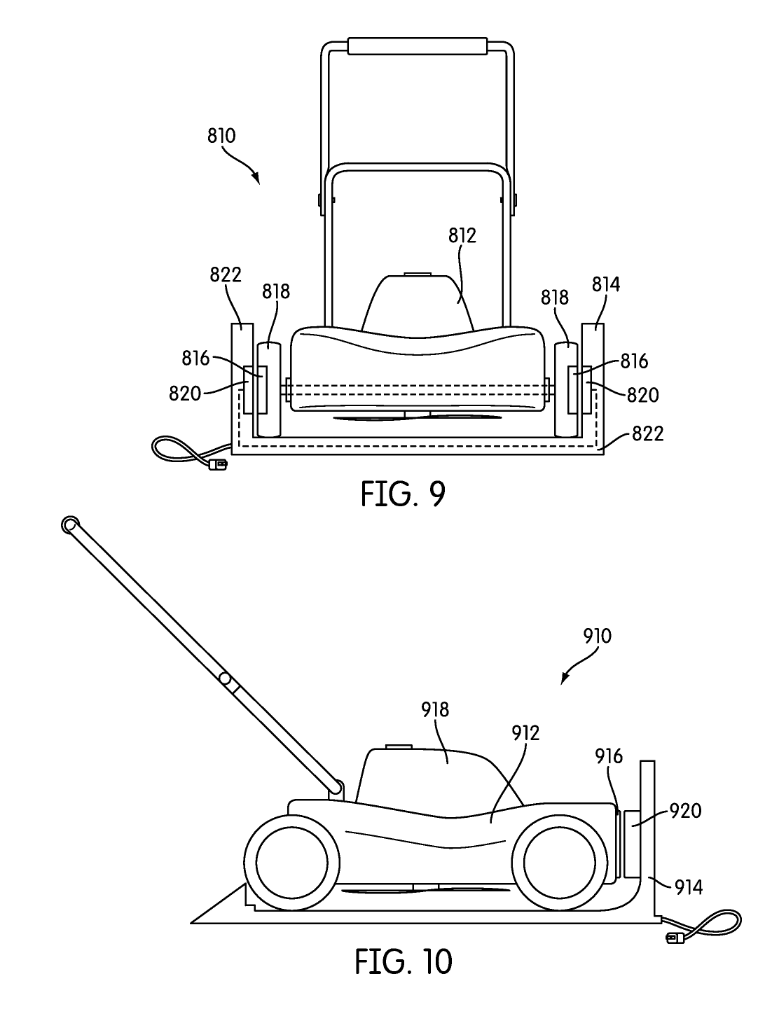

Referring to FIG. 9, a lawn mower system 810 includes a battery-powered, walk-behind lawn mower 812 and a charging station 814 configured to communicate power to a battery of the lawn mower 812 via induction. For storage or charging, the lawn mower 812 may be rolled onto the charging station 814. According to an exemplary embodiment, the charging station may include features, such as the lips, ramps, and recesses (see generally charging stations 114, 310 as shown in FIGS. 1 and 3).

According to an exemplary embodiment, the lawn mower 812 includes secondary coils 816 in hubs of wheels 818 of the lawn mower 812 and the charging station 814 includes primary coils 820 integrated in side walls 822 of the charging station 814. When the lawn mower 812 is positioned on the top surface of the charging station 814, the primary and secondary coils 816, 820 are aligned and configured to communicate power via induction for charging the lawn mower 812. In some embodiments, the lawn mower 812 includes only one secondary coil 816, such as in one of the wheel hubs. In other embodiments, the lawn mower 812 includes two or more secondary coils 816 configured to communicate with corresponding primary coils 820.

Referring now to FIG. 10, a lawn mower system 910 includes a lawn mower 912 and a charging station 914. The lawn mower 912 includes a secondary coil positioned in a panel 916 on top of a deck 918 of the lawn mower 912. The panel 916 is configured to be aligned with a corresponding primary panel 920 of the charging station 914, which includes a primary coil in the primary panel 920. When the lawn mower 912 is positioned so that the panels 916, 920 are proximate one another and facing one another, the secondary and primary coils of the panels 916, 920 are configured to communicate power for charging the lawn mower 912. In other embodiments, a panel containing a secondary coil may be positioned on a side or rear of the deck 918 of the lawn mower 912. In contemplated embodiments, a panel could be received in a recess to couple primary and secondary coils.

According to a contemplated embodiment, secondary and primary coils of a lawn mower system (see, e.g., lawn mower system 910 as shown in FIG. 10) are configured to communicate information via induction, such as using electric power transmission at a low enough bandwidth such that information may be carried on an electric field passed between the secondary and primary coils.

In contemplated embodiments, a lawn mower includes a state-of-charge sensor coupled to the battery. The state-of-charge sensor may include a voltmeter in combination with an expected discharge curve for the battery saved in memory of circuitry of the lawn mower system. In other embodiments, the state-of-charge sensor may include circuitry configured for integration of the current into and out of the battery. According to an exemplary embodiment, the state-of-charge sensor provides data as to the available capacity of the battery, which may be communicated by a controller to the activate or deactivate the charging station. When the battery is full, the charging station is deactivated.

In contemplated embodiments, a lawn mower system includes a display. The indicia on the display may include information such as the status of charging. In some such embodiments, a display, such as a red light-emitting diode, may indicate whether the coils are properly aligned. In other embodiments, a display, such as a green light-emitting diode, may indicate whether the charging station is presently charging the lawn mower. Other information displayed may include the projected time remaining for charging, or the percentage of the battery of the lawn mower currently charged. In some contemplated embodiments, the display may be coupled to the lawn mower proximate to the handle. In other contemplated embodiments, the display may be coupled to the charging station, elsewhere, or in combinations of locations.

In contemplated embodiments, a lawn mower includes a passive code that is configured to be sensed by the charging station. The code may be used to indicate that the lawn mower is present on the charging station. In some embodiments, the code may include a passive electronic tag, such as a radio-frequency identification tag, coupled to the lawn mower. A reader in the charging station may then read the tag to verify that the lawn mower is on the charging station.

In other contemplated embodiments, the charging station may include a mechanical key, such as an actual key or a unique feature of the lawn mower that engages a switch on the charging station when the lawn mower is positioned on the charging station. For example, the lawn mower may include a unique wheelbase, and placement of all four wheels of the lawn mower on pressure-sensitive switches or buttons may indicate the presence of the lawn mower to the charging station, which may then initiate charging.

While FIGS. 1-2 and 5-10 show walk-behind lawn mowers, in other contemplated embodiments, other equipment may use features disclosed herein. In contemplated embodiments, charging stations and secondary coils may be used with decks of riding lawn mowers. In some embodiments, a battery-powered pressure washer includes a secondary coil configured for use with a charging station as described herein. The battery and motor of the pressure washer may be sealed, and induction charging of the battery may be used without exposing conductive elements to water associated with the pressure washer. Similarly, battery-powered snow throwers may benefit from the induction charging technology disclosed herein.

In contemplated embodiments, a charging station, including one or more of the features of charging stations disclosed herein, may be used with multiple power tools. For example, the same charging station may be configured to charge a battery of a walk-behind lawn mower, a battery-powered roto-tiller with a secondary coil, and a battery-powered handheld leaf blower. In contemplated embodiments, a charging station may include multiple ports (e.g., matrix of primary coils) and may be configured to charge multiple tools at one time, where communication between the tools and the charging station is used by a computerized controller to efficiently operate the multiple ports.

The construction and arrangements of the lawn mower system, power equipment, and charging station for power equipment, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, ultra-capacitors or other developing types of secondary batteries may be used instead of a conventional rechargeable battery in some contemplated embodiments. Also, the motor with a rechargeable battery could be the primary motor of the power equipment, or a starter motor for a combustion engine in some embodiments. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lawn mower system, comprising:
a lawn mower comprising:
a rechargeable battery;
an electric motor powered by the battery; and
a secondary coil electrically coupled to the battery; and
a charging station comprising a primary coil configured to induce a current in the secondary coil for charging the battery of the lawn mower.

2. The lawn mower system of claim 1, wherein the secondary coil is integrated with a deck of the lawn mower.

3. The lawn mower system of claim 2, wherein the secondary coil is integrated with a rim of the deck.

4. The lawn mower system of claim 1, wherein the charging station is configured to receive the lawn mower on top of the charging station to facilitate communication of power between the primary and secondary coils.

5. The lawn mower system of claim 4, wherein the charging station comprises a recess configured to receive and constrain the lawn mower such that the primary and secondary coils are positioned so as to be able to communicate power between one another for charging the battery.

6. The lawn mower system of claim 5, wherein the charging station comprises a ramp extending to a lip over which the lawn mower may roll in order to position the lawn mower in the recess for charging the battery.

7. The lawn mower system of claim 1, wherein the primary and secondary coils are resonant at about the same frequency.

8. The lawn mower system of claim 1, further comprising a switch configured to interrupt communication of power from the battery to the motor of the lawn mower while the primary and secondary coils are communicating power between one another.

9. A charging station for power equipment, comprising:
a platform configured to receive the power equipment for charging, comprising:
a lip configured to constrain movement of the power equipment;
a ramp extending to the lip and configured to facilitate moving the power equipment over the lip without lifting the power equipment off of the platform; and
a recessed surface; and
a coil integrated into the platform and configured to provide a field for charging the power equipment via induction.

10. The charging station of claim 9, wherein the lip is contoured to allow an operator to move the power equipment backward over the lip to disengage the coil without lifting the power equipment off of the platform.

11. The charging station of claim 10, wherein the ramp extends along a side of the platform.

12. The charging station of claim 11, wherein the charging station further comprises a second lip extending along another side of the platform, and wherein the second lip is taller than the lip.

13. The charging station of claim 12, wherein the second lip comprises two sections that extend along opposite sides of the platform, and wherein the recessed surface extends between the two sections.

14. The charging station of claim 10, wherein the lip has a height of at least a half inch greater than the recessed surface.

15. The charging station of claim 14, wherein the ramp has a slope of sixty degrees or less above horizontal.

16. Power equipment, comprising:
a frame having wheels;
a rechargeable battery;
an electric motor supported by the frame and configured to be receive power from the battery; and
a coil configured to generate a current via induction for charging the battery.

17. The power equipment of claim 16, further comprising:
a tool configured to be rotated by the motor; and
a housing supported by the frame and at least partially surrounding the tool, wherein the coil is integrated into the housing.

18. The power equipment of claim 17, wherein the tool is a lawn mower blade and the housing is a lawn mower deck, and wherein the coil is integrated with a rim of the deck.

19. The power equipment of claim 17, further comprising a switch configured to interrupt communication of power from the battery to the motor while the coil is charging the battery.

20. The power equipment of claim 17, wherein the coil is integrated in a panel coupled to a top or side surface of the deck.
